(19) United States
(12) Patent Application Publication
(10) Pub. No.: US 2026/0152379 A1
(43) Pub. Date: Jun. 4, 2026

(54) CUTTING AND COUPLING METHOD AND SYSTEM

(71) Applicant: Roberto TROVI, Quarrata (PT) (IT)

(72) Inventor: Roberto TROVI, Quarrata (PT) (IT)

(21) Appl. No.: 19/405,357

(22) Filed: Dec. 1, 2025

(30) Foreign Application Priority Data
Dec. 2, 2024 (IT) 102024000027189

(51) Int. Cl. B68G 7/12

(52) U.S. Cl. CPC B68G 7/12

(57) ABSTRACT

Cutting and coupling method, including the steps of: arranging a first sheet of resilient material onto a first cutting station; arranging a spring pack onto a first bearing plane adjacent to a first coupling area; cutting a first portion of said first sheet, said first portion defining a first spar; moving said first spar towards a first coupling area adjacent to said first bearing plane; applying a layer of adhesive to at least one of a first lateral surface of said spring pack and said first spar at a contact surface; gluing said first lateral surface of said spring pack to said first spar.

This application claims priority to Italian Patent Application 102024000027189 filed Dec. 2, 2024, the entirety of which is incorporated by reference herein.

The present invention relates to a cutting and coupling method and system.

In particular, the present invention relates to a method for cutting a plurality of spars and coupling them to a spring pack for making a semi-finished product intended for the production of spring mattresses.

Spring mattresses are a type of mattress that contain a set of springs, generally held together (the springs) by a fabric cover or connecting elements.

In addition to the spring pack, the spring mattress also includes at least one lower resilient material sheet, one upper resilient material sheet, and a number of side edges, known as spars, which are also made of resilient material.

The present invention also relates to a cutting and coupling system.

Today, spring mattresses are made using purely manual or semi-automatic procedures, which generally consist of the following sequence of steps.

First, a bottom sheet is prepared and the spring pack is placed centrally theron.

The bottom sheet extends over a larger area than the spring pack so as to leave a peripheral cord on the bottom sheet exposed and allow the subsequent positioning of the aforementioned spar on the cord itself.

The spars are glued to the bottom sheet and are positioned resting only on the spring pack.

At this point, the top sheet is positioned to close the mattress, with the possible addition of further sheets with different resilience characteristics or other features, known as “comfort layers.”

The methods and systems currently used to manufacture spring mattresses have various drawbacks.

In particular, one drawback of the known methods and systems is their inadequate production speed.

In fact, these methods often involve slow and laborious manual actions.

Another drawback of the known methods and systems is that they do not allow for adequate assembly quality.

To overcome these problems, there are now methods and systems for pre-assembling a semi-finished product that forms a single body consisting of a spring pack and perimeter spars glued to it.

The manufacturing of a semi-finished product makes it possible to speed up and standardize the subsequent operations for assembling a complete spring mattress.

These semi-finished products are currently manufactured using semi-automatic systems.

The known methods of assembling a semi-finished product are not without drawbacks.

In fact, they are often slow and cumbersome.

Another drawback is that the quality of the finished product is not always optimal.

It is therefore an object of the present invention to provide a cutting and coupling method and system capable of overcoming the drawbacks of the current state of the art.

Another object of the present invention is to provide a cutting and coupling method and system capable of optimizing production times.

Another object of the present invention is to provide a cutting and coupling method and system capable of ensuring optimal production quality.

According to the invention, these and other objects are achieved by a cutting and coupling method and system having the technical characteristics described in the attached claims.

The technical characteristics of the invention, according to the above objects, are clearly described in the attached claims, and its advantages are apparent from the detailed description that follows, with reference to the attached drawings that illustrate purely exemplary and non-limiting embodiments, wherein:

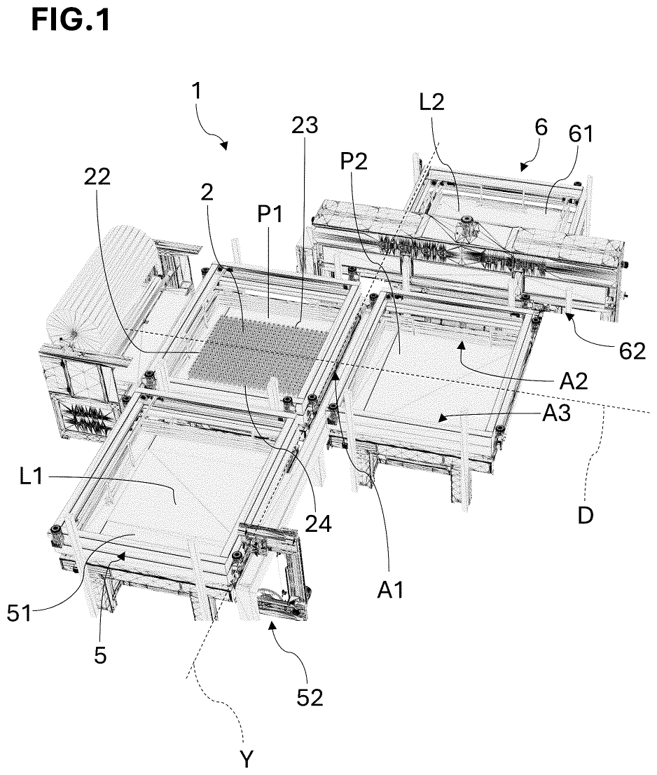

FIG. 1 illustrates a schematic perspective view from above of a cutting and coupling system according to the present invention, and

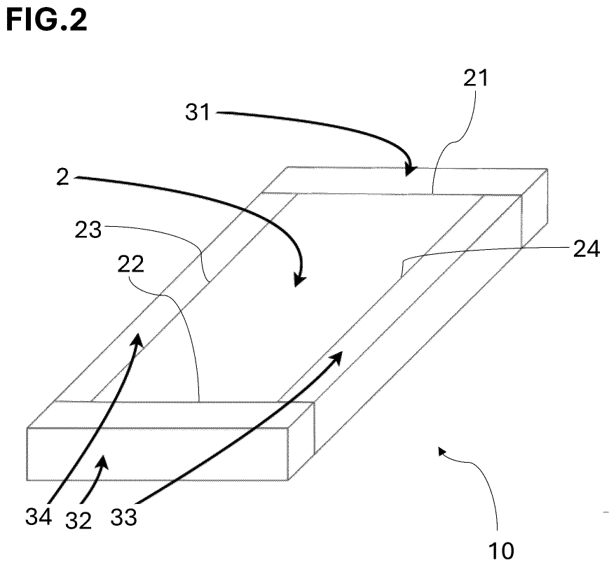

FIG. 2 illustrates a schematic perspective view from above of a semi-finished product made using the system shown in FIG. 1.

The subject matter of the present invention is a cutting and coupling method, hereinafter also referred to simply as the “method.”

The method according to the present invention comprises a step of placing a first sheet L1 of resilient material onto a first cutting station 5.

By resilient material it is meant a material that has the ability to absorb mechanical energy, deform under the action of a force and then return to its original shape once the force ceases to act.

By “Sheet” it is meant a body made of resilient material, substantially parallelepiped in shape, geometrically defined by three orthogonal dimensions: length, width, and thickness.

The sheet L1 is placed onto a support base 51 of the cutting station 5 in a flat and extended configuration.

In this flat and extended configuration, the sheet L1 is free of residual stresses or elastic curvatures typical of previously rolled materials, ensuring perfect flatness without the need for straightening or unwinding devices.

The method of the present invention comprises a step of placing a spring pack 2 on a first support surface P1 adjacent to a first coupling area A1.

The method comprises a step of cutting a first portion of the first sheet L1.

This first portion defines a first spar 31.

Advantageously, the thickness of the cut spar is predetermined according to the specific type of mattress being manufactured.

Advantageously, the step of arranging the first sheet L1 comprises a step of arranging the first sheet L1 so that the first sheet L1 emerges from a cutting line by a predetermined distance to obtain the first spar 31. This distance corresponds to the thickness of the spar, predetermined according to the type of mattress being produced.

Advantageously, the sheet L1 is designed with a length and thickness already calibrated to correspond exactly to the final dimensions of the spar 31 to be applied to the spring pack 2.

Thanks to this feature, the cutting operation performed at station 5 is limited exclusively to separating the spar along the width of the plate, i.e., making a longitudinal cut with respect to the sheet.

Therefore, no cross-cutting operation is required to adjust the length, nor are any thickness adjustment operations required, since the newly separated spar 31 already has the correct geometry for immediate coupling with the corresponding lateral surface 21 of the spring pack.

Adjusting the width allows different mattresses to be obtained from the same sheet L1, which may require different spar widths.

The method includes a step of moving the first spar 31 towards the first coupling area A1 adjacent to the first bearing plane P1.

This step of moving the first spar 31 therefore takes place after the first portion of the first sheet L1 has been cut.

Advantageously, the moving step is carried out by means of a conveyor belt along a vertical Y direction.

Alternatively, the moving step is carried out by means of at least a partially motorized roller conveyor or by means of a pusher.

The method according to the present invention comprises a step of applying a layer of adhesive to at least one of a first lateral surface 21 of the spring pack 2 and the first spar 31 at a contact surface.

Advantageously, the step of applying a layer of adhesive is carried out by spreading.

Alternatively, the step of applying a layer of adhesive is carried out by spraying.

The method according to the present invention comprises a step of gluing the first lateral surface 21 of the spring pack 2 to the first spar 31.

This gluing step advantageously comprises a step of applying mutual pressure between the first lateral surface 21 and the first spar 31.

Advantageously, the method according to the present invention comprises a step of gluing at least one additional spar 32, 33, 34 onto the spring pack 2.

Advantageously, the step of gluing at least one additional spar 32, 33, 34 comprises the steps of:
moving the spring pack 2 onto a second bearing plane P2 adjacent to the first plane P1, so that a second lateral surface 22 of the spring pack 2 faces the first coupling area A1;
cutting a second portion of the first sheet L1, so that this second portion defines a second spar 32;
moving the second spar 32 towards the first coupling area A1 adjacent to the second bearing plane P2;
applying a layer of adhesive to at least one of the second lateral surface 22 of the spring pack 2 and the second spar 32 at a contact surface;
gluing the second lateral surface 22 of the spring pack 2 to the second spar 32.

The step of transferring the spring pack 2 onto a second plane P2 is carried out by moving it along a horizontal direction D, advantageously perpendicular to the vertical direction Y along which the spars are moved.

Advantageously, the step of gluing the second lateral surface 22 includes a step of applying reciprocal pressure between the second spar 32 and the spring pack 2.

These steps allow a first and a second spar to be applied to opposite lateral surfaces of the spring pack 2.

Advantageously, these first and second spar 31 and 32 are applied to the short sides of spring pack 2.

Alternatively, these first and second spars 31 and 32 are applied to the long sides of the spring pack 2.

It should be understood that the distinction between long side and short side is to be made when the spring pack 2 has a rectangular shape.

If the spring pack 2 has a square shape, it clearly makes no difference which side a respective spar is applied to.

Advantageously, the step of gluing at least one further spar 32, 33, 34 comprises the steps of:
placing a second sheet L2 of resilient material onto a second cutting station 6;
moving the spring pack 2 onto a second bearing plane P2 so that a third lateral surface 23 of the spring pack 2 faces a second coupling area A2, and so that a fourth lateral surface 24 of the spring pack 2 faces a third coupling area A3;
cutting a first portion of the second plate L2 defining a third spar 33;
moving the third spar 33 towards the third coupling area A3;
applying a layer of adhesive to at least one of the fourth lateral surface 24 of the spring pack 2 and the third spar 33 at a contact surface;
gluing the fourth lateral surface 24 of the spring pack 2 to said third spar 33;
cutting a second portion of the second sheet L2 defining a fourth spar 34;
moving the fourth spar 34 towards the second coupling area A2;
applying a layer of adhesive to at least one of the third lateral surface 23 of the spring pack 2 and the fourth spar 34 at a contact surface;
gluing the third lateral surface 23 of the spring pack 2 to the fourth spar 34.

These steps allow the third and fourth spar 33, 34 to be applied.

Similar to what was described for the first sheet L1, the step of arranging a second sheet L2 involves placing it in an extended configuration onto the second station 6.

The second sheet L2 has predefined dimensions in terms of length and thickness corresponding to the final dimensions of the third and fourth spar 33, 34 to be obtained.

Advantageously, the third and fourth spar 33, 34 are applied to the respective long sides of the spring pack 2, while the first and second spar 31, 32 are applied to the respective short sides, and vice versa.

A further aspect of the present invention is a cutting and coupling system 1, hereinafter referred to simply as “system 1.”

With reference to the attached FIG. 1, the system 1 according to the present invention includes a first cutting station 5.

This first cutting station 5 is configured to accommodate and cut a first sheet L1 of resilient material.

The first cutting station 5 comprises a support base 51 for the first sheet L1 and a cutting device 52 designed to cut the first sheet L1 to obtain at least one first spar 31.

Specifically, the support base 51 is shaped to accommodate the entire planar extension of the first sheet L1 in an extended configuration.

The cutting device 52 is configured to operate on the sheet L1, performing a separation cut along the predefined length of the sheet itself.

The system 1 includes a bearing plane P 1 adjacent to a first coupling area A1 and designed to support a spring pack 2.

With reference to FIG. 2, the spring pack 2 has four lateral surfaces 21, 22, 23, 24.

According to the embodiment illustrated in the attached figures, the spring pack 2 has a pair of short sides and a pair of long sides, i.e., it is rectangular in shape.

The system 1 that is the subject of this invention comprises first means for moving the aforementioned first spar 31 from the first cutting station 5 to the first coupling area A1.

The system 1 comprises first gluing means (not shown) arranged near the first coupling area A1 and designed to apply an adhesive layer to at least one first lateral surface 21 of the spring pack 2 and the first spar 31 so as to couple them securely.

Advantageously, the system 1 comprises second moving means designed to move the spring pack 2 along a horizontal direction D towards a second bearing plane P2.

The cutting device 52 advantageously allows the first sheet L1 to be cut to obtain a first and a second spar 31, 32.

The first moving means are designed to move the second spar 32 towards the first coupling area A1 when the spring pack 2 is located on the second bearing plane P2.

This allows the second spar 32 to be glued to the second lateral surface 22 of the spring pack 2.

The second lateral surface 22 is opposite the first lateral surface 21.

Advantageously, the system 1 includes a second station 6 for cutting a second sheet L2 of resilient material.

The second cutting station 6 comprises a support base 61 for the second sheet L2, and a cutting device 62 designed to cut the second sheet L2 to obtain a third and fourth spar 33, 34.

The base 61 of the second station 6 is structured to support the entire surface of the second sheet L2 in an extended configuration.

The system 1, object of the present invention, advantageously includes third moving means designed to move the third spar 33 towards a third coupling area A3, and a fourth spar 34 towards a second coupling area A2.

Each of the cutting stations 5 and 6 allows the thickness of the spars to be adjusted.

This allows the cut to be adapted to any desired thickness.

Advantageously, the cutting stations 5 and 6 also allow the obtained spars 31, 32, 33, 34 to be cut to length, so as to further adapt these spars to a specific spring pack 2, in order to obtain any semi-finished product 10 of the desired dimensions.

In particular, the third coupling area A3, according to the embodiment illustrated in FIG. 1, is arranged near the fourth lateral surface 24 of the spring pack 2, when the spring pack 2 is arranged on the second bearing plane P2.

The second coupling area A 2 is located in proximity to a third lateral surface 23 of the spring pack 2, when the spring pack 2 is arranged on the second bearing plane P2.

Advantageously, the system 1 includes second gluing means arranged in proximity to the second coupling area A2.

The second gluing means are designed to apply an adhesive layer to at least one of the third lateral surface 23 of the spring pack 2 and the fourth spar 34 in order to couple them permanently.

Advantageously, the system 1 comprises third gluing means arranged in proximity to the third coupling area A3.

The second gluing means are designed to apply an adhesive layer to at least one of the fourth lateral surface 24 of the spring pack 2 and the third spar 33 in order to couple them securely.

The system 1 of the present invention therefore allows a semi-finished product 10 to be obtained by coupling the spring pack 2 and the four spars 31, 32, 33, 34.

The method and system of the present invention allow the drawbacks of the prior art to be overcome and significant advantages to be achieved.

One advantage of the method and system according to the present invention is that it optimizes the production speed of a semi-finished product.

This is ensured by the special combination of technical characteristics defined by the cutting mechanism and the shape of the L1 and L2 sheets, which already have the length and thickness dimensions that are intended for the spars obtained therefrom.

This ensures optimal coupling by simply adjusting the width of the spar during cutting.

Another advantage of the method and system according to the present invention is that it ensures optimal production quality of semi-finished products for the subsequent manufacture of spring mattresses.

Another advantage of the method and system according to the present invention is that it ensures optimized management of the spars, minimizing their handling before coupling with the spring pack.

Another advantage of the method and system according to the present invention is that it optimizes the handling of the thicknesses of the spars.

The cutting stations in the system covered by this invention allow thicknesses to be adjusted to ensure optimal results regardless of the semi-finished product model to be obtained.

Furthermore, this invention makes it possible to continuously produce even small batches of mattresses of different sizes, as the cutting devices are controlled on a case-by-case basis to define the correct thickness of the spars themselves.

1. A cutting and coupling method, comprising the following steps in precise order:
arranging a first sheet of resilient material onto a support base of a first cutting station, in an extended configuration;
arranging a spring pack onto a first bearing plane adjacent to a first coupling area;
cutting a first portion of said first sheet, said first portion defining a first spar;
moving said first spar towards a first coupling area adjacent to said first bearing plane;
applying a layer of adhesive to at least one of a first lateral surface of said spring pack and said first spar at a contact surface;
gluing said first lateral surface of said spring pack to said first spar.

2. The method according to claim 1, wherein it comprises a step of gluing at least one further spar onto said spring pack.

3. The method according to claim 1, wherein said step of gluing at least one further spar comprises the steps of:
transferring said spring pack onto a second bearing plane adjacent to said first bearing plane, so that a second lateral surface of said spring pack faces said first coupling area;
cutting a second portion of said first sheet, said second portion defining a second spar;
moving said second spar towards said first coupling area adjacent to said second bearing plane;
applying a layer of glue onto at least one of said second lateral surface of said spring pack and said second spar at a contact surface;
gluing said second lateral surface of said spring pack with said second spar.

4. The method according to claim 2, wherein said step of gluing at least one further spar comprises the steps of:
arranging a second sheet of resilient material onto a second cutting station;
moving said spring pack on said second bearing plane so that a third lateral surface of said spring pack faces a second coupling area, and so that a fourth lateral surface of said spring pack faces a third coupling area;
cutting a first portion of said second sheet defining a third spar;
moving said third spar towards said third coupling area;
applying a layer of glue onto at least one of said fourth lateral surface of said spring pack and said third spar at a contact surface;
gluing said fourth lateral surface of said spring pack with said third spar;
cutting a second portion of said second sheet defining a fourth spar;
moving said fourth spar towards said second coupling area;
applying a layer of glue onto at least one of said third lateral surface of said spring pack and said fourth spar at a contact surface;
gluing said third lateral surface of said spring pack with said fourth spar.

5. A cutting and coupling system, comprising:
a first cutting station of a first sheet of resilient material, said first cutting station comprising a support base for said first sheet and a cutting device designed to cut said first sheet so as to obtain at least one first spar;
a bearing plane adjacent to a first coupling area and designed to support a spring pack, said spring pack having four lateral surfaces;
first moving means of said at least one first spar from said first cutting station towards said first coupling area;
first gluing means arranged in proximity to said first coupling area and designed to apply an adhesive layer onto at least one of a first lateral surface of said spring pack and said first spar so as to couple them stably; said system being characterized by the fact that it comprises second moving means for moving said spring pack along a horizontal direction towards a second bearing plane, and by the fact that said cutting device allows said first sheet to be cut to obtain a first and a second spar (31, 32), said first moving means being designed to move said second spar towards said first coupling area when said spring pack is located on said second bearing plane, so that said second spar can be glued to a second lateral surface of said spring pack, said second lateral surface being opposite said first lateral surface.

6. The system according to claim 5, wherein it comprises a second cutting station for cutting a second sheet of resilient material, said second cutting station comprising a support base for said second sheet and a cutting device designed to cut said second sheet so as to obtain a third and a fourth spar.

7. The system according to claim 6, wherein it comprises third moving means suitable for moving said third spar towards a third coupling area, and a fourth spar towards a second coupling area,
said third coupling area being arranged in proximity to a fourth lateral surface of said spring pack, when said spring pack is arranged on said second plane,
said second coupling area being arranged in proximity to a third lateral surface of said spring pack, when said spring pack is arranged on said second plane.

8. The system according to claim 7, wherein it comprises second gluing means arranged in proximity to said second coupling area and designed to apply an adhesive layer onto at least one of a third lateral surface of said spring pack and said fourth spar so as to couple them stably.

9. The system according to claim 7, wherein it comprises third gluing means arranged in proximity to said third coupling area and suitable for applying an adhesive layer onto at least one of a fourth lateral surface of said spring pack and said third spar so as to couple them stably.
